(19) United States
(12) Patent Application Publication
(10) Pub. No.: US 2026/0187119 A1
(43) Pub. Date: Jul. 2, 2026

(54) EVENT CONTEXT GENERATION METHOD AND APPARATUS, DEVICE, MEDIUM AND PROGRAM PRODUCT

(71) Applicant: Beijing Zitiao Network Technology Co., Ltd., Beijing (CN)

(72) Inventors: Jiezheng DIAO, Beijing (CN); Yuheng HE, Beijing (CN); Shan BAI, Beijing (CN); Yipeng HUANG, Beijing (CN); Liu LIU, Beijing (CN); Pengchao FENG, Beijing (CN); Duju ZENG, Beijing (CN)

(21) Appl. No.: 19/431,480

(22) Filed: Dec. 23, 2025

(30) Foreign Application Priority Data
Dec. 30, 2024 (CN) 202411978192.3

(51) Int. Cl. G06F 16/334

(52) U.S. Cl. CPC G06F 16/334

(57) ABSTRACT

An event context generation method and apparatus, a device, a medium and a program product are provided. The method includes: acquiring a plurality of candidate texts, and determining at least one candidate text set based on degrees of association among candidate texts in the plurality of candidate texts; determining a plurality of popularity intervals, based on a posting time of candidate texts in each candidate text set, a preset target-text number and text attributes of the candidate texts; for each popularity interval, determining a target text in the popularity interval, based on a target text set corresponding to the candidate texts in the popularity interval; and generating an event context based on event associated information of each target text.

### CROSS-REFERENCE TO RELATED APPLICATION

The present application claims priority to Chinese Patent Application No. 202411978192.3 filed on Dec. 30, 2024, which is incorporated by reference in its entirety as a part of the present application.

### TECHNICAL FIELD

Embodiments of the present disclosure relate to the computer technology, and specifically relates to an event context generation method and apparatus, a device, a medium and a program product.

### BACKGROUND

Event context refers to continuous descriptive analysis on social events from occurrence to end. The event context is used to understand the cause, process, and result of the events.

Currently, a large number of texts related to the events are usually obtained by searching in a news library, and then the large number of texts are sampled to obtain text samples, and the text samples are subjected to context extraction to obtain the event context. However, generating a sampling strategy for the large number of texts requires a wealth of experience, and an inappropriate sampling strategy will affect the accuracy of the event context.

### SUMMARY

Embodiments of the present disclosure provide an event context generation method and apparatus, a device, a medium and a program product.

An event context generation method is provided by embodiments of the present disclosure. This method includes:
acquiring a plurality of candidate texts, and determining at least one candidate text set based on degrees of association among candidate texts in the plurality of candidate texts;
determining a plurality of popularity intervals, based on a posting time of candidate texts in each candidate text set, a preset target-text number (for example, a preset first-text number) and text attributes of the candidate texts;
for each popularity interval, determining a target text (for example, a first text) in the popularity interval, based on a target text set (for example, a first text set) corresponding to the candidate texts in the popularity interval; and
generating an event context based on event associated information of each target text.

An event context generation apparatus is also provided by embodiments of the present disclosure. This apparatus includes:
a set determination module, configured to acquire a plurality of candidate texts, and determine at least one candidate text set based on degrees of association among candidate texts in the plurality of candidate texts;
an interval determination module, configured to determine a plurality of popularity intervals, based on a posting time of candidate texts in each candidate text set, a preset target-text number (for example, a preset first-text number) and text attributes of the candidate texts;
a text determination module, configured to, for each popularity interval, determine a target text (for example, a first text) in the popularity interval, based on a target text set (for example, a first text set) corresponding to the candidate texts in the popularity interval; and
a context generation module, configured to generate an event context based on event associated information of each target text.

An electronic device is also provided by embodiments of the present disclosure. This electronic device includes:
one or more processors; and
a storage apparatus configured to store one or more programs, wherein
when the one or more programs are executed by the one or more processors, the one or more processors implement the event context generation method according to the embodiments of the present disclosure.

A storage medium including a computer-executable instruction is also provided by embodiments of the present disclosure. The computer-executable instruction, when executed by a computer processor, is configured to implement the event context generation method according to the embodiments of the present disclosure.

A computer program product is also provided by embodiments of the present disclosure. The computer program product includes a computer program, and the computer program, when executed by a processor, is configured to implement the event context generation method according to the embodiments of the present disclosure.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, same or similar reference numerals indicate same or similar elements. It should be understood that the drawings are schematic, and the originals and elements are not necessarily drawn to scale.

FIG. 1 is a schematic flowchart of an event context generation method provided by an embodiment of the present disclosure;

FIG. 2 is a schematic flowchart of an event context generation method provided by another embodiment of the present disclosure;

FIG. 3 is a schematic diagram of division of popularity intervals based on a set sorting result provided by an embodiment of the present disclosure;

FIG. 4 is a schematic diagram of a context extraction strategy in an event context generation method provided by an embodiment of the present disclosure;

FIG. 5 is a flow schematic diagram of another event context generation method provided by an embodiment of the present disclosure;

FIG. 6 is a schematic structural diagram of an event context generation device provided by an embodiment of the present disclosure; and

FIG. 7 is a schematic structural diagram of an electronic device provided by an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “include”, “comprise” and their variants are open-ended including, that is, “including but not limited to”. The term “based on” is “at least partially based on”. The term “one embodiment” means “at least one embodiment”. The term “another embodiment” means “at least one other embodiment”. The term “some embodiments” means “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a”, “an” and “a plurality of” mentioned in the present disclosure are schematic rather than limiting, and those skilled in the art should understand that unless the context clearly indicates otherwise, they should be understood as “one or more”.

Names of messages or information exchanged among a plurality of apparatuses in the embodiments of the present disclosure are only used for illustrative purposes, and are not used to limit the scope of these messages or information.

It can be understood that before using the technical solutions disclosed in various embodiments of present disclosure, users should be informed of the types, scope of use, use scenarios, etc. of personal information involved in present disclosure in an appropriate way according to relevant laws and regulations and be authorized by users.

For example, in response to receiving the user's active request, prompt information is sent to a user to clearly remind the user that the requested operation will require obtaining and using the user's personal information. Therefore, the user can independently choose whether to provide personal information to software or hardware such as electronic devices, applications, servers or storage media that perform the operation of the technical solution of the present disclosure according to the prompt information.

As an optional but non-limiting implementation, in response to receiving the user's active request, the way to send the prompt information to the user can be, for example, a pop-up window, in which the prompt information can be presented in text. In addition, the pop-up window can also carry a selection control for the user to choose “agree” or “disagree” to provide personal information to the electronic device.

It can be understood that the above process of notifying and obtaining user authorization is only schematic, and does not limit the implementation of the present disclosure. Other ways to meet relevant laws and regulations can also be applied to the implementation of the present disclosure.

It can be understood that the data involved in this technical solution (including but not limited to the data itself, data acquisition or use) shall comply with the requirements of corresponding laws, regulations and relevant regulations.

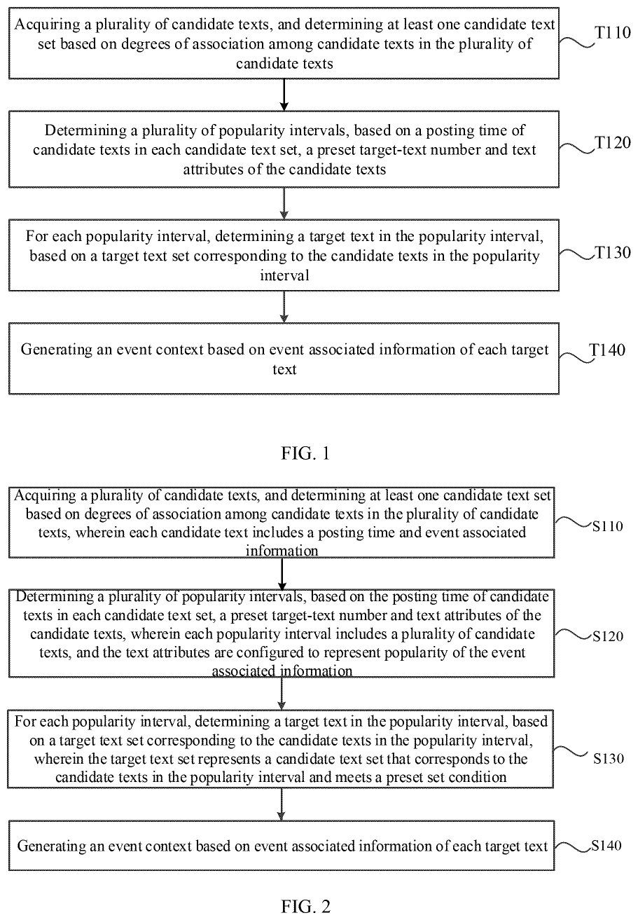

FIG. 1 is a schematic flowchart of an event context generation method provided by an embodiment of the present disclosure. This embodiment of the present disclosure is applicable in information processing scenarios, such as scenarios of tracking hot news or handling public opinion. This method can be executed by an event context generation device, which can be implemented in a form of software and/or hardware. Optionally, it can be implemented by an electronic device, which may be a mobile terminal, a PC, or a server, etc.

As shown in FIG. 1, the method includes:
T110: acquiring a plurality of candidate texts, and determining at least one candidate text set based on degrees of association among candidate texts in the plurality of candidate texts.
T120: determining a plurality of popularity intervals, based on a posting time of candidate texts in each candidate text set, a preset target-text number and text attributes of the candidate texts.
T130: for each popularity interval, determining a target text in the popularity interval, based on a target text set corresponding to the candidate texts in the popularity interval.
T140: generating an event context based on event associated information of each target text.

According to this embodiment of the present disclosure, the target text is determined according to the target text set corresponding to the candidate texts in the popularity interval, the candidate texts in each popularity interval are stably sampled based on the popularity to obtain the target text, and therefore, the stability and accuracy of the event context can be improved.

In some embodiment of the present disclosure, each candidate text includes a posting time and event associated information, each popularity interval includes a plurality of candidate texts, and the text attributes are configured to represent popularity of the event associated information; and the first text set represents a candidate text set that corresponds to the candidate texts in the popularity interval and meets a preset set condition.

FIG. 2 is a schematic flowchart of an event context generation method provided by another embodiment of the present disclosure.

As shown in FIG. 2, the method includes:
S110: acquiring a plurality of candidate texts, and determining at least one candidate text set based on degrees of association among candidate texts in the plurality of candidate texts, wherein each candidate text includes a posting time and event associated information.

The candidate text may be a text for reporting news events. For example, the candidate text includes a news text related to the news events. The news text can be acquired from a preset news database. For example, the plurality of candidate texts are acquired by searching with preset keywords in the preset news database. The candidate text includes the posting time and the event associated information. The event associated information includes text content associated with the news events. Event node information corresponding to the event associated information can be obtained by performing event context extraction on the event associated information. The event context to be generated includes a plurality of pieces of event node information. The event node information includes node time information, event description information and the like. Event nodes may represent sub-events that influence the progress of the news events. The node time information represents the occurrence time of the sub-events of the news events. The event description information is used for representing the content of the sub-events of the news events. For example, an event A occurred on 20th of xx month in xx year. On 21st of xx month in xx year, an event B associated with the event A occurred, and on 22nd of xx month in xx year, an event C associated with the event B occurred. In the afternoon on 22nd of xx month in xx year, an event D associated with the event A and the event C occurred. In the above examples, the event A, the event B, the event C, and the event D are all event nodes.

The candidate text set represents the set of the candidate texts. The plurality of candidate texts with high degrees of association may be divided into one candidate text set based on the degrees of association among the candidate texts in the plurality of candidate texts, so as to obtain the at least one candidate text set. Optionally, the degrees of association among the candidate texts may be determined based on vector similarity between the candidate texts. For example, vectorization processing is performed on each candidate text to obtain candidate text vectors. Clustering is performed on a plurality of candidate text vectors based on a preset vector similarity threshold so as to obtain at least one candidate text set. Specifically, each candidate text vector may be compared to determine a plurality of candidate texts with similarity higher than a preset similarity threshold. The plurality of candidate texts with the similarity higher than the preset similarity threshold are divided into the same candidate text set. Optionally, a plurality of clustering centers may be determined from the plurality of candidate texts, and the vector similarity between candidate texts and the corresponding clustering centers is compared to determine at least one candidate text with the similarity higher than the preset similarity threshold. The at least one candidate text with the similarity higher than the preset similarity threshold and the corresponding clustering center are divided into the same candidate text set.

In this embodiment of the present disclosure, keywords associated with the event context to be generated are acquired and are used for searching in the preset news database, so as to obtain the plurality of candidate texts associated with the event context to be generated. The candidate texts with similar content of the same event may be obtained by searching in a keyword search mode. In an event context generation stage, the event context extraction is performed on the candidate texts with the similar content, consequently, repeated event context will be extracted, which will waste analysis resources and affect the generation efficiency of the event context. In order to solve the above problems, clustering processing may be performed on the candidate texts based on the text content, so as to cluster the candidate texts with the similar content in the same candidate text set.

Optionally, an extremely high preset similarity threshold may be set, so that the candidate texts in the same candidate text set may be treated as the candidate texts with the same content.
S120: determining a plurality of popularity intervals, based on the posting time of candidate texts in each candidate text set, a preset target-text number and text attributes of the candidate texts, wherein each popularity interval includes a plurality of candidate texts, and the text attributes are configured to represent popularity of the event associated information.

The popularity interval represents the set of the candidate text sets. Each popularity interval includes several candidate texts. For example, a single popularity interval may include at least one complete candidate text set, or some of the candidate texts in the candidate text set, or at least one complete candidate text set and some of the candidate texts in at least another candidate text set. A popularity information range of each popularity interval may be determined based on the preset target-text number and the text attribute of each candidate text. The preset target-text number represents the total number of target texts to be sampled from the candidate texts. The preset target-text number may be preset or manually inputted. The preset target-text number may be determined based on the complexity of the event context to be generated.

The text attribute is used for representing the popularity of the event associated information. For example, the text attribute includes at least one selected from the group consisting of the total number of candidate texts, forwarding amount, comment amount and like amount.

Exemplarily, for each candidate text set, a posting time of the candidate text set is determined based on the posting time of the candidate texts in the candidate text set. The at least one candidate text set is sorted based on the posting time of each candidate text set to obtain a set sorting result. The set sorting result is divided into the plurality of popularity intervals based on the preset target-text number and the text attributes of each candidate text.

Optionally, for each candidate text set, the candidate texts in the current candidate text set may be sorted based on the posting time of the candidate texts in the current candidate text set, and the posting time of the current candidate text set is determined based on the sorting result. Then, the at least one candidate text set is sorted based on the posting time of the candidate text set so as to obtain the set sorting result. By sorting the at least one candidate text set, the candidate text set may be strung into a queue based on the posting time, which is convenient for the subsequent division of the at least one candidate text set based on the popularity.

Specifically, for each candidate text set, each candidate text in the current candidate text set may be sorted from earliest to latest based on the posting time of each candidate text in the current candidate text set. Based on the sorting result, an earliest posting time of the candidate texts in the current candidate text set is taken as the posting time of the current candidate text set. Each candidate text set is sorted based on the posting time from earliest to latest to obtain the set sorting result.

The total popularity of the plurality of candidate texts is determined based on the text attributes of each candidate text. For example, the total popularity of the plurality of candidate texts may be determined based on at least one selected from the group consisting of the forwarding amount, comment amount and like amount of each candidate text. Or, the total popularity of the plurality of candidate texts is determined based on the total number of the candidate texts. Based on the preset target-text number and the total popularity of the plurality of candidate texts, the popularity information range of each popularity interval is determined, and then the set sorting result is segmented based on the popularity information range to obtain the plurality of popularity intervals.

Optionally, the dividing the set sorting result into the plurality of popularity intervals based on the preset target-text number and the text attributes of each candidate text includes: determining popularity information corresponding to each candidate text set based on the text attributes of the candidate texts in each candidate text set; determining a popularity information range of each popularity interval based on the preset target-text number and the text attributes of each candidate text; and dividing the candidate text set in the set sorting result to obtain the plurality of popularity intervals based on the popularity information range and the popularity information of the candidate text set.

Exemplarily, for each candidate text set, the sum of at least one selected from the group consisting of the total number of the candidate texts in the current candidate text set, the forwarding amount, like amount and comment amount is determined as the popularity information of the current candidate text set. The popularity information range of each popularity interval is determined, based on the preset target-text number and the total popularity of the plurality of candidate texts. For example, the following formula may be adopted to calculate the popularity information range P=total popularity/(n−1), wherein, P represents the popularity information of the single popularity interval, and n represents the preset target-text number.

Taking the total popularity of 800 and the preset target-text number of 5 as an example, the popularity of the single popularity interval may be known as 200 through the above formula. Therefore, the popularity information range of a first popularity interval is 0-200, the popularity information range of a second popularity interval is 200-400, the popularity information range of a third popularity interval is 400-600, and the popularity information range of a fourth popularity interval is 600-800. The popularity information of each candidate text set is the sum of the popularity of the candidate texts in the set, so the candidate text set in the set sorting result may be divided based on the popularity information range of each popularity interval and the popularity information of each candidate text set, so as to obtain the plurality of popularity intervals. For example, it is assumed that the popularity information of the first candidate text set in the set sorting result is 130, which is insufficient to fill the first popularity interval. It is needed to inspect the second candidate text set in the set sorting result. It is assumed that the popularity information of the second candidate text set in the set sorting result is 20, in combination with the popularity information of the first candidate text set and the second candidate text set, it is still insufficient to fill the first popularity interval. It is needed to inspect the third candidate text set in the set sorting result. It is assumed that the popularity information of the third candidate text set in the set sorting result is 282, only some of the candidate texts in the third candidate text set are needed, in combination with the first candidate text set and the second candidate text set, it can fill the first popularity interval. Therefore, the first candidate text set, the second candidate text set and some of the candidate texts in the third candidate text set are divided into the first popularity interval. For example, the top 50 candidate texts are divided into the first interval according to the sorting result of the candidate texts in the third candidate text set. Or, the top m candidate texts with the popularity sum of 50 are divided into the first interval according to the sorting result of the candidate texts in the third candidate text set. The popularity sum of the candidates is determined based on at least one selected from the group consisting of the forwarding amount, like amount and comment amount. The division modes of the second popularity interval, the third popularity interval and the fourth popularity interval are the same as the division mode of the first popularity interval, which will not be listed here.

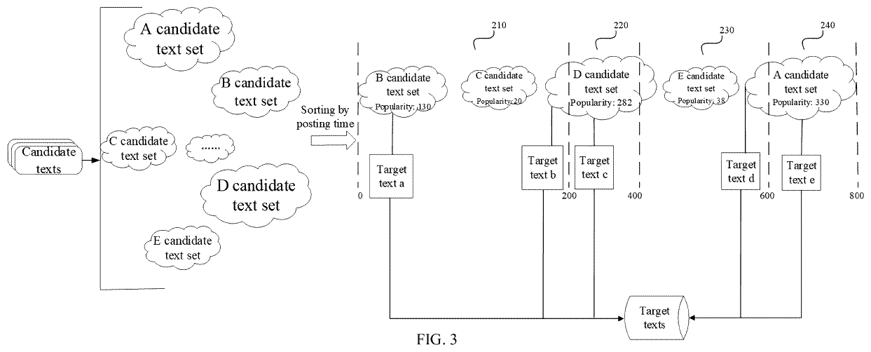

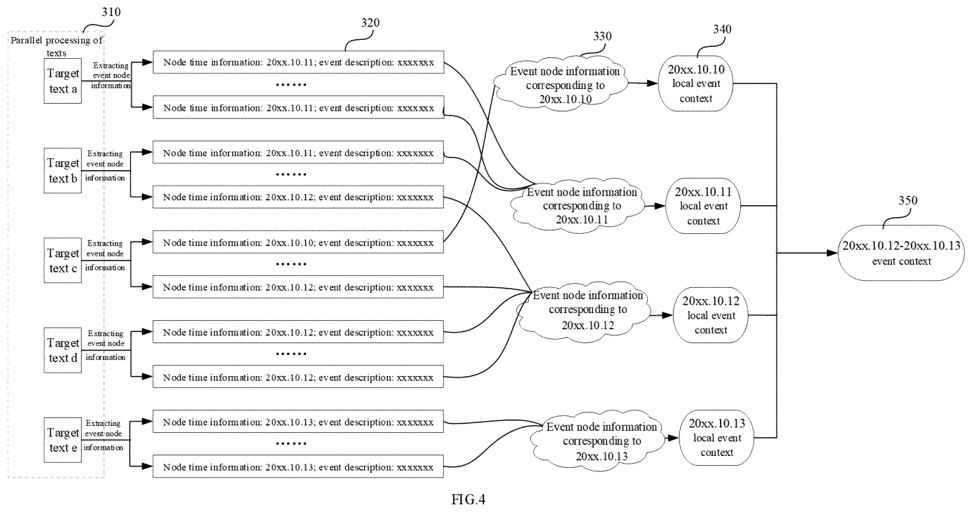

FIG. 3 is a schematic diagram of division of popularity intervals based on a set sorting result provided by an embodiment of the present disclosure. As shown in FIG. 3, the vectorization processing and clustering processing are performed on the candidate texts to obtain the candidate text sets which include an A candidate text set, a B candidate text set, a C candidate text set, a D candidate text set and an E candidate text set. The posting time of the A candidate text set is January 22, with the popularity of 330. The posting time of the B candidate text set is January 17, with the popularity of 130. The posting time of the C candidate text set is January 19, with the popularity of 20. The posting time of the D candidate text set is January 20, with the popularity of 282. The posting time of the E candidate text set is January 21, with the popularity of 38. Each candidate text set is sorted according to the posting time of the candidate text set, so that the candidate text sets are arranged in the sequence of B candidate text set→C candidate text set→D candidate text set→E candidate text set→A candidate text set. Since the total popularity of the candidate text set is 800, and the preset target-text number is 5, the popularity information range of the popularity intervals is as follows: the popularity information range of the first popularity interval 210 is [0, 200], the popularity information range of the second popularity interval 220 is [200, 400], the popularity information range of the third popularity interval 230 is [400, 600], and the popularity information range of the fourth popularity interval 240 is [600, 800]. The set sorting result is divided based on the popularity information range of the popularity intervals and the popularity information of each candidate text set. As shown in FIG. 3, the B candidate text set, the C candidate text set and a part of the D candidate text set belong to the first popularity interval 210. A part of the D candidate text set belongs to the second popularity interval 220. The remaining part of the D candidate text set, and of the E candidate text set and a part of the A candidate text set belong to the third popularity interval 230. The remaining part of the A candidate text set belongs to the fourth popularity interval 240.

It should be noted that the above formula provides an example for uniformly dividing the set sorting result to obtain the popularity interval; and in the present disclosure, the set sorting result may be non-uniformly divided according to the posting time or popularity information of the candidate text set and the like, which is not specifically limited in this embodiment of the present disclosure.

For example, the set sorting result may be divided in a gradual narrowing mode along with the posting time from earliest to latest so as to obtain a gradually narrowing popularity interval. Or, as the posting time goes on, the popularity interval may be gradually narrowed, and then the popularity interval is gradually expanded. The development rules of a news event may be that when the news event occurs, it is only concerned in a small range, and as time goes on, the popularity of the news event continuously increases, so that the total number of candidate texts correspondingly increases. By narrowing the popularity interval, the candidate text set with high popularity may be divided into the plurality of popularity intervals, and thus, the sampling frequency of the candidate text set with high popularity is increased. For some news events, as the event progressed to the end, the popularity of the news event is gradually decreases, the candidate text set corresponding to the news event can be sampled by the popularity interval which is gradually decreases and then gradually increased, thus the sampling frequency of the candidate text set with high popularity can be increased; additionally, after the popularity is decreases, the candidate text sets with low popularity are prevented from being sampled by increasing the popularity interval, so that the total number of target texts to be analyzed in the event context generation stage can be reduced, and computing resources can be saved.
S130: for each popularity interval, determining a target text in the popularity interval, based on a target text set corresponding to the candidate texts in the popularity interval, wherein the target text set represents a candidate text set that corresponds to the candidate texts in the popularity interval and meets a preset set condition.

In this embodiment of the present disclosure, the preset set condition is associated with the posting time and the popularity information of the candidate text set. For example, the preset set condition may include: determining the target text set based on the popularity sorting result of the candidate text set corresponding to the candidate texts in the popularity interval. The preset set condition may include: taking the candidate text set with the highest popularity corresponding to the candidate texts in the popularity interval as the target text set corresponding to the candidate texts in the popularity interval. The preset set condition may also include: determining the candidate text set with the earliest posting time as the target text set corresponding to the popularity interval including the candidate text with the earliest posting time.

The target text represents the candidate text that meets a preset sampling strategy in the popularity interval. For example, the preset sampling strategy includes: taking the earliest posted candidate text in the candidate text set with the earliest posting time as the target text; taking the earliest posted candidate text in the candidate text set with the highest popularity in each popularity interval as the target text; and in response to the earliest posted candidate text in the candidate text set with the highest popularity being determined as the target text, taking the candidate text, corresponding to the boundary of the popularity interval, of the candidate text set with the highest popularity as the target text.

With reference to FIG. 3, since the candidate text sets are sorted according to the posting time of the candidate text sets from earliest to latest, the candidate text with the earliest posting time in the first candidate text set (namely, the B candidate text set) is taken as the target text. Then, for the first popularity interval, the popularity information of the B candidate text set, the popularity information of the C candidate text set and the popularity information of the D candidate text set are compared, and the D candidate text set is determined to be the candidate text set with the maximum popularity in the first popularity interval. The candidate text with the earliest posting time in the D candidate text set is acquired and taken as the target text. Because the second popularity interval only contains the D candidate text set and the candidate text with the final posting time in the D candidate text set is sampled, so the candidate text with the earliest posting time in the second popularity interval (including the interval boundary) is determined as the target text. The similar sampling strategy is adopted in the third popularity interval and the fourth popularity interval, which will not be listed here.

Target texts include the earliest posted candidate texts in all the candidate text sets. Optionally, in order to ensure that the sampled target text is positively associated with the popularity of the candidate text set, the candidate text set may be partitioned according to the popularity to obtain the plurality of popularity intervals. The target text is selected from the candidate texts in each popularity interval based on the posting time. For the candidate text set with higher popularity, it may belong to at least one popularity interval, so the higher the sampling probability of the candidate text set with higher popularity is, and the distribution of the target text is ensured to be positively associated with the popularity.

Optionally, after the dividing the candidate text set in the set sorting result to obtain the plurality of popularity intervals, the method further includes: for each popularity interval, determining a target text set corresponding to the candidate text in the popularity interval based on the popularity information of the candidate text set corresponding to the candidate text in the popularity interval.

Optionally, the for each popularity interval, determining a target text in the popularity interval based on the target text set corresponding to the candidate text in the popularity interval includes:
determining a target text in each popularity interval based on the posting time of the candidate text in the target text set in each popularity interval.

For example, for each popularity interval, the candidate text set corresponding to the candidate texts in the current popularity interval is determined. It should be noted that the candidate text sets corresponding to the candidate texts in the current popularity interval includes: the candidate text set in the current popularity interval, and the candidate text set of some of the candidate texts in the current popularity interval. By comparing the popularity information of the candidate text set corresponding to the candidate texts in the current popularity interval, the candidate text set with the maximum popularity corresponding to the candidate texts in the current popularity interval can be obtained and taken as the target text set. The target text in each popularity interval is determined based on the posting time of the candidate texts in the target text set in each popularity interval.
S140: generating an event context based on event associated information of each target text.

In this embodiment of the present disclosure, the event node information corresponding to the event associated information can be obtained by performing event context extraction operation on the event associated information. For example, each target text is inputted into a pre-trained context extraction model, and event context extraction is performed on the target texts by the context extraction model to obtain the event node information. The event node information includes node time information, event description information and the like. For example, the node time information is 20th of xx month in xx year. The event node description includes that an event a occurred, and the event a is xxxx.

Exemplarily, the generating the event context based on the event associated information of each target text includes: determining event node information of each target text based on event associated information of each target text; dividing the event node information of each target text based on node time information in the event node information of each target text, to obtain at least one event node set; determining a local event context corresponding to each event node set based on the event node information in each event node set; and splicing each local event context based on the node time information to generate the event context.

The event node set represents the set of event node information. Optionally, by dividing the event node information every time through the node time information, at least one event node set can be obtained. For example, the event node information with the same node time information may be divided into a same event node set. The event node information with different node time information is divided into different event node sets.

It should be noted that the pre-trained context extraction model is a generative language model that is trained based on a pre-prepared training sample set. The training sample set includes training samples and event node information corresponding to the training samples. The training samples may include news events in various fields such as entertainment, sports, education, and science and technology. By inputting training samples into the context extraction model to be trained, the model training is supervised through the event node information corresponding to the training samples. For example, the model prediction loss is determined based on the event node information corresponding to the training samples and the event node information extracted by the model. The context extraction model is trained based on the model prediction loss. Optionally, the training sample set of the pre-trained context extraction model further includes: event node information samples and content summary samples corresponding to the event node information samples. By inputting the event node information samples into the pre-trained context extraction model, the model training is supervised by the content summary samples corresponding to the event node information samples. Optionally, the training sample set of the pre-trained context extraction model further includes: content summary samples of the event node information and event context samples of the complete event contexts. By inputting the content summary samples into the pre-trained context extraction model, the model training is supervised by the event context samples, so that the context extraction model learns the knowledge related to splicing each local event context into the complete event context. Optionally, the training sample set of the pre-trained context extraction model further includes: content summary samples of the event node information and event abstract samples. By inputting the content summary samples into the pre-trained context extraction model, the model training is supervised by the event abstract samples, so that the context model learns the knowledge of summarizing and organizing the content summary of each event node information into an event abstract.

The local event context represents the local content of the complete event context. For example, the local event context is a context line corresponding to the event node information in each event node set. The event node information corresponding to each event node set may be inputted into the context extraction model, and content summarization is performed on the event node information based on the context extraction model so as to obtain the core content of the event node information. The local event context corresponding to each event node set is determined based on the core content of the event node information corresponding to the event node set. Because the node time information of the event node information in the same event node set is the same, the node time information of the event node information in the event node set may be taken as the set time of the event node set. Each local event context is spliced based on the set time of each event node set so as to obtain the complete event context.

The target text may be inputted into the pre-trained context extraction model, and the event node information in the target text is extracted by the context extraction model. The plurality of pieces of event node information are divided based on the node time information of each event node information corresponding to each target text, so as to obtain a plurality of event node sets. For example, when the event context is constructed according to the dimension of days, events occurred on the same day belong to the same event node set. Optionally, when the event context is constructed according to the dimension of weeks, events occurred on the same week belong to the same event node set. Optionally, when the event context is constructed according to the dimension of half a day, events occurred in the morning of the same day belong to the same event node set, and events occurred in the afternoon of the same day belong to another event node set. Content summarization is performed on the event node information in the event node set by the context extraction model, so as to obtain the core content of the event node information. The local event context is determined based on the core content of the event node information corresponding to the event node set. The local event contexts corresponding to the event node sets are spliced to obtain the event context. A complex event context generation task is divided into local event context generation tasks that can be processed in parallel, so that the time consumption of the context generation tasks is reduced.

Optionally, the core content of the event node information corresponding to each event node set is integrated by the context extraction model to determine the event abstract.

FIG. 4 is a schematic diagram of a context extraction strategy in an event context generation method provided by an embodiment of the present disclosure. As shown in FIG. 4, an event node information extraction operation is executed in parallel on event associated information of each target text 310, to obtain event node information 320 of each target text 310. The event node information 320 includes node time information and event description. The event node information 320 is divided according to the node time information to obtain at least one event node set 330. A local event context 340 corresponding to each event node set is determined based on the event node information in the event node set 330. Each local event context 340 is spliced based on the node time information of each event node set to obtain an event context 350.

According to the technical solution provided by this embodiment of the present disclosure, the method includes: acquiring the plurality of candidate texts, and determining at least one candidate text set based on degrees of association among candidate texts in the plurality of candidate texts; determining the plurality of popularity intervals based on the posting time of the candidate texts in each candidate text set, the preset target-text number and the text attributes of the candidate text; for each popularity interval, determining the target text in the popularity interval based on the target text set corresponding to the candidate texts in the popularity interval; and generating an event context based on event associated information of each target text. According to the technical solution provided by this embodiment of the present disclosure, the target text is determined based on the target text set corresponding to the candidate texts in the popularity interval, the candidate texts in each popularity interval are stably sampled based on the popularity to obtain the target text, and thus, the stability and accuracy of the event context can be improved. In addition, the local event context is determined based on the event node set, and thus the local event context is generated in parallel; and then the complete event context is obtained in combination with each local event context, and thus the time consumption of generating the event context is reduced.

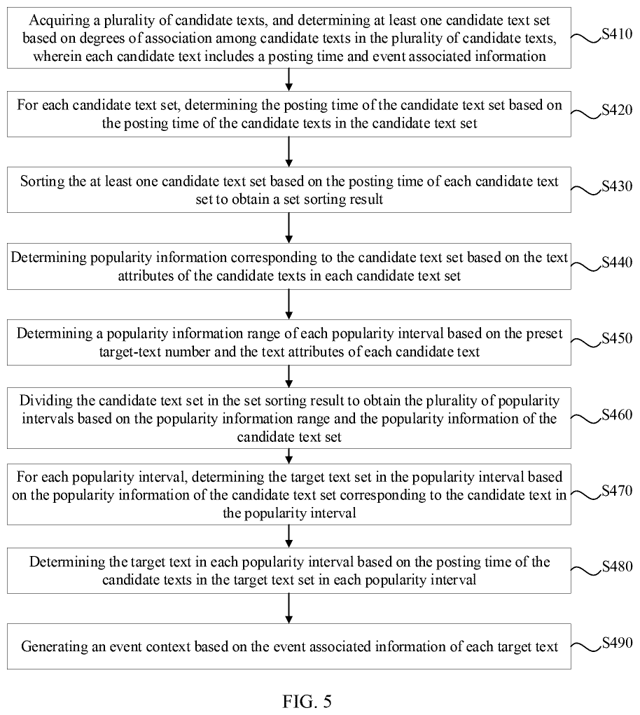

FIG. 5 is a flow schematic diagram of another event context generation method provided by an embodiment of the present disclosure; and on the basis of the above embodiments, in this embodiment of the present disclosure, the posting time of the candidate texts in the target text set in each popularity interval is further defined, and the target text in each popularity interval is determined.

As shown in FIG. 5, the method includes:
S410: acquiring a plurality of candidate texts, and determining at least one candidate text set based on degrees of association among candidate texts in the plurality of candidate texts, wherein each candidate text includes a posting time and event associated information.
S420: for each candidate text set, determining the posting time of the candidate text set based on the posting time of the candidate texts in the candidate text set.
S430: sorting the at least one candidate text set based on the posting time of each candidate text set to obtain a set sorting result.
S440: determining popularity information corresponding to the candidate text set based on the text attributes of the candidate texts in each candidate text set.
S450: determining a popularity information range of each popularity interval based on the preset target-text number and the text attributes of each candidate text.
S460: dividing the candidate text set in the set sorting result to obtain the plurality of popularity intervals based on the popularity information range and the popularity information of the candidate text set.
S470: for each popularity interval, determining the target text set in the popularity interval based on the popularity information of the candidate text set corresponding to the candidate text in the popularity interval.
S480: determining the target text in each popularity interval based on the posting time of the candidate texts in the target text set in each popularity interval.

Exemplarily, for the popularity interval corresponding to the candidate text set with the earliest posting time, the target text in the popularity interval is determined based on the posting time of each candidate text in the candidate text set with the earliest posting time. For each popularity interval, a sorting result of the candidate texts in the target text set is determined based on the posting time of the candidate texts in the target text set in the popularity interval, and the target text in the popularity interval is determined based on the sorting result.

For example, the earliest posted candidate text in the candidate text set with the earliest posting time is treated as the target text, which ensures that the first posting time of the news event can be sampled, thus the accuracy of the timeline of the event context is guaranteed, and the problem of timeline lag of the event context is avoided.

For each popularity interval, the sorting result of candidate texts in the target set is determined according to the posting time of the candidate texts in the target text set in the popularity interval. For example, the candidate texts in the target text set can be sorted according to the posting time from earliest to latest.

Optionally, the determining the target text in the popularity interval based on the sorting result, includes:
determining the target text in the popularity interval based on a candidate text with the earliest posting time in the target text set.

Or,
determining the target text in the popularity interval based on a candidate text located at the boundary of the popularity interval in the target text set.

If the candidate texts in the target text set are sorted from according to the release time from earliest to latest, the candidate text with the earliest posting time in the target text set is determined as the target text based on the sorting result of the candidate texts in the target text set. If the candidate text with the earliest posting time in the target text set corresponding to the current popularity interval is sampled, the candidate text of the target text set at the left boundary of the current popularity interval is treated as the target text. With reference to FIG. 3, for the second popularity interval, since the candidate text with the earliest posting time in the D candidate text set is sampled, the candidate text (i.e., the candidate text ranked 50th in the D candidate text set) of the D candidate text set at the left boundary of the second popularity interval is treated as the target text. All the sampling strategies are pure linear operations, and there are no nonlinear operations such as activation processing, so that the stability of the sampling result is ensured.

It should be noted that if the candidate texts in the target text set are sorted based on the posting time from latest to earliest, the candidate text with the earliest posting time in the target text set corresponding to the current popularity interval is determined as the target text, and the candidate text of the target text set at the right boundary of the current popularity interval can be treated as the target text.
S490: generating an event context based on the event associated information of each target text.

Optionally, whether each target text contains different development stages of the same news event is determined, and texts, which are not of the same news event as other target texts, in the target texts are filtered out. For example, content understanding is performed on the target text by the context extraction model, whether each target text contains the same event description is determined, and if so, it is determined that the target text belongs to the same news event.

Then, event context extraction is performed on each filtered target text by the context extraction model so as to obtain the event node information in each target text. The event node information is divided based on the node time information in the event node information so as to obtain at least one event node set. Content summarization is performed on the event node information in each event node set so as to obtain the core content of the event node information. The local event context corresponding to the event node set is determined based on the core content of the event node information. The local event context corresponding to the event node set is spliced according to the node time information to obtain the complete event context.

According to the technical solution provided by this embodiment of the present disclosure, the target text is determined based on the posting time of the candidate texts in the candidate text set with the earliest posting time; and for each popularity interval, the sorting result of the candidate texts in the target text set is determined based on the posting time of the candidate texts in the target text set in the popularity interval, and the target text in the popularity interval is determined based on the sorting result. According to the technical solution provided by this embodiment of the present disclosure, the target text in the candidate text set with the earliest posting time is acquired based on the posting time, so that the first posting time of the event context can be stably and accurately sampled, and the timeline lag of the event context is avoided. The target text set corresponding to each popularity interval is sampled at least once, so as to ensure that the target text follows the event popularity distribution, and the integrity of the event is ensured while the data volume is reduced.

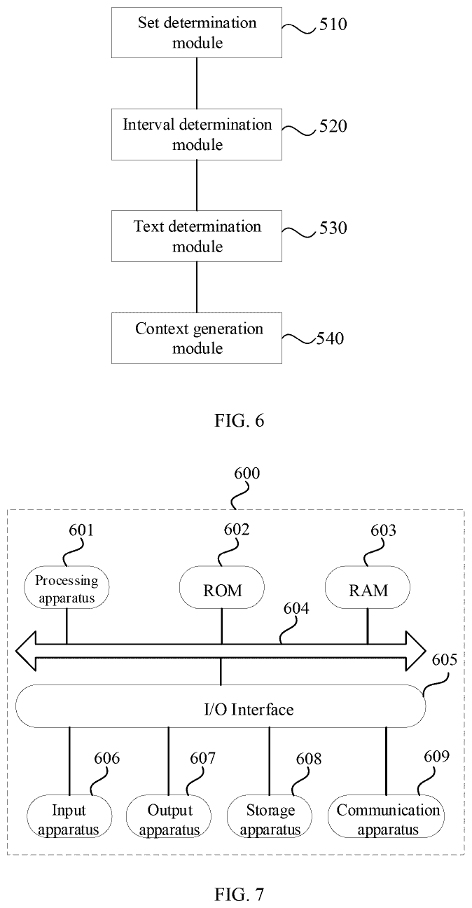

FIG. 6 is a schematic structural diagram of an event context generation apparatus provided by an embodiment of the present disclosure. The apparatus can be implemented in a form of software and/or hardware, optionally, by an electronic device, which can be a mobile terminal, a PC or a server, etc.

As shown in FIG. 6, the apparatus includes: a set determination module 510, an interval determination module 520, a text determination module 530 and a context generation module 540.

The set determination module 510 is configured to acquire a plurality of candidate texts, and determine at least one candidate text set based on degrees of association among candidate texts in the plurality of candidate texts, wherein each candidate text includes a posting time and event associated information;
the interval determination module 520 is configured to: determine a plurality of popularity intervals, based on the posting time of candidate texts in each candidate text set, a preset target-text number and text attributes of the candidate texts, wherein each popularity interval includes a plurality of candidate texts, and the text attributes are configured to represent popularity of the event associated information;
the text determination module 530 is configured to, for each popularity interval, determine a target text in the popularity interval, based on a target text set corresponding to the candidate texts in the popularity interval, wherein the target text set represents a candidate text set that corresponds to the candidate texts in the popularity interval and meets a preset set condition; and
the context generation module 540 is configured to generate an event context based on event associated information of each target text.

Optionally, the interval determination module 520 is specifically configured to:
for each candidate text set, determine the posting time of the candidate texts set based on the posting time of the candidate texts in the candidate text set;
sort the at least one candidate text set based on the posting time of each candidate text set to obtain a set sorting result; and
divide the set sorting result into the plurality of popularity intervals based on the preset target-text number and the text attributes of each candidate text.

Further, the dividing the set sorting result into the plurality of popularity intervals based on the preset target-text number and the text attributes of each candidate text includes:
determining popularity information corresponding to each candidate text set based on the text attributes of the candidate texts in each candidate text set;
determining a popularity information range of each popularity interval based on the preset target-text number and the text attributes of each candidate text; and
dividing the candidate text set in the set sorting result to obtain the plurality of popularity intervals based on the popularity information range and the popularity information of the candidate text set.

Optionally, after the dividing the candidate text set in the set sorting result to obtain the plurality of popularity intervals, the method further includes:
for each popularity interval, determining the target text set corresponding to the candidate texts in the popularity interval based on the popularity information of the candidate text set corresponding to the candidate texts in the popularity interval.

Optionally, the text determination module 530 is specifically configured to:
determine the target text in each popularity interval based on the posting time of candidate texts in the target text set in each popularity interval.

Further, the determining the target text in each popularity interval based on the posting time of candidate texts in the target text set in each popularity interval includes:
for a popularity interval corresponding to the candidate text set with an earliest posting time, determining the target text in the popularity interval based on the posting time of each candidate text in the candidate text set with the earliest posting time; and
for each popularity interval, determining a sorting result of the candidate texts in the target text set based on the posting time of the candidate texts in the target text set in the popularity interval, and determining the target text in the popularity interval based on the sorting result.

Further, the determining the target text in the popularity interval based on the sorting result includes:
determining the target text in the popularity interval based on a candidate text with the earliest posting time in the target text set;

Or,
determining the target text in the popularity interval based on a candidate text located at the boundary of the popularity interval in the target text set.

Optionally, the context generation module 540 is specifically configured to:
determine event node information of each target text based on event associated information of each target text;
divide the event node information of each target text based on node time information in the event node information of each target text, to obtain at least one event node set;
determine a local event context corresponding to each event node set based on the event node information in each event node set; and
splice each local event context based on the node time information to generate the event context.

The event context generation apparatus provided by this embodiment of the present disclosure can execute the event context generation method provided in any embodiment of the present disclosure, and has the corresponding functional module for performing the method and has the corresponding beneficial effect.

It should be noted that each unit and module included in the above-mentioned apparatus are only divided according to the functional logic, but are not limited to the above-mentioned division, as long as the corresponding functions can be realized; in addition, the specific name of each functional unit is only for the convenience of distinguishing and is not used for limiting the scope of protection of the embodiments of the present disclosure.

FIG. 7 is a schematic structural diagram of an electronic device (such as a terminal device or a server in FIG. 7) provided by an embodiment of the present disclosure. Referring to FIG. 7, FIG. 7 illustrates a schematic structural diagram of an electronic device 600 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 600 may include a processing apparatus 601 (e.g., a central processing unit, a graphics processing unit, etc.), which can perform various suitable actions and processing according to a program stored in a read-only memory (ROM) 602 or a program loaded from a storage apparatus 608 into a random-access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatus may be connected to the I/O interface 605: an input apparatus 606 including, for example, a touch screen, a touch pad, a keyboard, a mouse, a camera, a microphone, an accelerometer, a gyroscope, or the like; an output apparatus 607 including, for example, a liquid crystal display (LCD), a loudspeaker, a vibrator, or the like; a storage apparatus 608 including, for example, a magnetic tape, a hard disk, or the like; and a communication apparatus 609. The communication apparatus 609 may allow the electronic device 600 to be in wireless or wired communication with other devices to exchange data. While FIG. 7 illustrates the electronic device 600 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 609 and installed, or may be installed from the storage apparatus 608, or may be installed from the ROM 602. When the computer program is executed by the processing apparatus 601, the above-mentioned functions defined in the methods of some embodiments of the present disclosure are performed.

Names of messages or information exchanged among a plurality of apparatuses in the embodiment of the present disclosure are only used for illustrative purposes, and are not used to limit the scope of these messages or information.

The electronic device provided by the embodiment of the present disclosure belongs to the same inventive concept as the event context generation method provided by the above embodiment, and the technical details not described in detail in this embodiment can be found in the above embodiment, and this embodiment has the same beneficial effects as the above embodiment.

The embodiment of the present disclosure provides a computer storage medium on which a computer program is stored. The program, when executed by a processor, implement the event context generation method provided in the above embodiment.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
acquire a plurality of candidate texts, and determining at least one candidate text set based on degrees of association among candidate texts in the plurality of candidate texts, wherein each candidate text includes a posting time and event associated information;
determine a plurality of popularity intervals, based on the posting time of candidate texts in each candidate text set, a preset target-text number and text attributes of the candidate texts, wherein each popularity interval includes a plurality of candidate texts, and the text attributes are configured to represent popularity of the event associated information;
for each popularity interval, determine a target text in the popularity interval, based on a target text set corresponding to the candidate texts in the popularity interval, wherein the target text set represents a candidate text set that corresponds to the candidate texts in the popularity interval and meets a preset set condition; and
generate an event context based on event associated information of each target text.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An event context generation method, comprising:
acquiring a plurality of candidate texts, and determining at least one candidate text set based on degrees of association among candidate texts in the plurality of candidate texts;
determining a plurality of popularity intervals, based on a posting time of candidate texts in each candidate text set, a preset first-text number and text attributes of the candidate texts;
for each popularity interval, determining a first text in the popularity interval, based on a first text set corresponding to the candidate texts in the popularity interval; and
generating an event context based on event associated information of each first text.

2. The method according to claim 1, wherein each candidate text comprises a posting time and event associated information, each popularity interval comprises a plurality of candidate texts, and the text attributes are configured to represent popularity of the event associated information; and
wherein the first text set represents a candidate text set that corresponds to the candidate texts in the popularity interval and meets a preset set condition.

3. The method according to claim 1, wherein the determining a plurality of popularity intervals, based on the posting time of the candidate text in each of the candidate text sets, a preset first-text number and text attributes of the candidate texts comprises:
for each candidate text set, determining the posting time of the candidate texts set based on the posting time of the candidate texts in the candidate text set;
sorting the at least one candidate text set based on the posting time of each candidate text set to obtain a set sorting result; and
dividing the set sorting result into the plurality of popularity intervals based on the preset first-text number and the text attributes of each candidate text.

4. The method according to claim 3, wherein the dividing the set sorting result into the plurality of popularity intervals based on the preset first-text number and the text attributes of each candidate text comprises:
determining popularity information corresponding to each candidate text set based on the text attributes of the candidate texts in each candidate text set;
determining a popularity information range of each popularity interval based on the preset first-text number and the text attributes of each candidate text; and
dividing the candidate text set in the set sorting result to obtain the plurality of popularity intervals based on the popularity information range and the popularity information of the candidate text set.

5. The method according to claim 4, wherein, after the dividing the candidate text set in the set sorting result to obtain the plurality of popularity intervals, the method further comprises:
for each popularity interval, determining the first text set corresponding to the candidate texts in the popularity interval based on the popularity information of the candidate text set corresponding to the candidate texts in the popularity interval.

6. The method according to claim 1, wherein the for each popularity interval, determining a first text in the popularity interval based on the first text set corresponding to the candidate texts in the popularity interval comprises:
determining the first text in each popularity interval based on the posting time of candidate texts in the first text set in each popularity interval.

7. The method according to claim 6, wherein the preset set condition is associated with the posting time of the candidate text set and the popularity information of the candidate text set; and
the determining the first text in each popularity interval based on the posting time of candidate texts in the first text set in each popularity interval comprises:
for a popularity interval corresponding to the candidate text set with an earliest posting time, determining the first text in the popularity interval based on the posting time of each candidate text in the candidate text set with the earliest posting time; and
for each popularity interval, determining a sorting result of the candidate texts in the first text set based on the posting time of the candidate texts in the first text set in the popularity interval, and determining the first text in the popularity interval based on the sorting result.

8. The method according to claim 7, wherein the determining the first text in the popularity interval based on the sorting result comprises:
determining the first text in the popularity interval based on a candidate text with the earliest posting time in the first text set; or,
determining the first text in the popularity interval based on a candidate text located at the boundary of the popularity interval in the first text set.

9. The method according to claim 1, wherein the generating the event context based on the event associated information of each first text comprises:
determining event node information of each first text based on event associated information of each first text;
dividing the event node information of each first text based on node time information in the event node information of each first text, to obtain at least one event node set;
determining a local event context corresponding to each event node set based on the event node information in each event node set; and
splicing each local event context based on the node time information to generate the event context.

10. An electronic device, comprising:
one or more processors; and
a storage apparatus configured to store one or more programs, wherein
when the one or more programs are executed by the one or more processors, the one or more processors implement an event context generation method, which comprises:
acquiring a plurality of candidate texts, and determining at least one candidate text set based on degrees of association among candidate texts in the plurality of candidate texts;
determining a plurality of popularity intervals, based on a posting time of candidate texts in each candidate text set, a preset first-text number and text attributes of the candidate texts;
for each popularity interval, determining a first text in the popularity interval, based on a first text set corresponding to the candidate texts in the popularity interval; and
generating an event context based on event associated information of each first text.

11. The electronic device according to claim 10, wherein each candidate text comprises a posting time and event associated information, each popularity interval comprises a plurality of candidate texts, and the text attributes are configured to represent popularity of the event associated information; and
wherein the first text set represents a candidate text set that corresponds to the candidate texts in the popularity interval and meets a preset set condition.

12. The electronic device according to claim 10, wherein the determining a plurality of popularity intervals, based on the posting time of the candidate text in each of the candidate text sets, a preset first-text number and text attributes of the candidate texts comprises:
for each candidate text set, determining the posting time of the candidate texts set based on the posting time of the candidate texts in the candidate text set;
sorting the at least one candidate text set based on the posting time of each candidate text set to obtain a set sorting result; and
dividing the set sorting result into the plurality of popularity intervals based on the preset first-text number and the text attributes of each candidate text.

13. The electronic device according to claim 12, wherein the dividing the set sorting result into the plurality of popularity intervals based on the preset first-text number and the text attributes of each candidate text comprises:
determining popularity information corresponding to each candidate text set based on the text attributes of the candidate texts in each candidate text set;
determining a popularity information range of each popularity interval based on the preset first-text number and the text attributes of each candidate text; and
dividing the candidate text set in the set sorting result to obtain the plurality of popularity intervals based on the popularity information range and the popularity information of the candidate text set.

14. The electronic device according to claim 13, wherein, after the dividing the candidate text set in the set sorting result to obtain the plurality of popularity intervals, the method further comprises:
for each popularity interval, determining the first text set corresponding to the candidate texts in the popularity interval based on the popularity information of the candidate text set corresponding to the candidate texts in the popularity interval.

15. The electronic device to claim 10, wherein the for each popularity interval, determining a first text in the popularity interval based on the first text set corresponding to the candidate texts in the popularity interval comprises:
determining the first text in each popularity interval based on the posting time of candidate texts in the first text set in each popularity interval.

16. The electronic device according to claim 15, wherein the preset set condition is associated with the posting time of the candidate text set and the popularity information of the candidate text set; and
the determining the first text in each popularity interval based on the posting time of candidate texts in the first text set in each popularity interval comprises:
for a popularity interval corresponding to the candidate text set with an earliest posting time, determining the first text in the popularity interval based on the posting time of each candidate text in the candidate text set with the earliest posting time; and
for each popularity interval, determining a sorting result of the candidate texts in the first text set based on the posting time of the candidate texts in the first text set in the popularity interval, and determining the first text in the popularity interval based on the sorting result.

17. A non-transitory storage medium comprising a computer-executable instruction, wherein the computer-executable instruction, when executed by a computer processor, is configured to implement an event context generation method, which comprises:
acquiring a plurality of candidate texts, and determining at least one candidate text set based on degrees of association among candidate texts in the plurality of candidate texts;
determining a plurality of popularity intervals, based on a posting time of candidate texts in each candidate text set, a preset first-text number and text attributes of the candidate texts;
for each popularity interval, determining a first text in the popularity interval, based on a first text set corresponding to the candidate texts in the popularity interval; and
generating an event context based on event associated information of each first text.

18. The non-transitory storage medium according to claim 17, wherein each candidate text comprises a posting time and event associated information, each popularity interval comprises a plurality of candidate texts, and the text attributes are configured to represent popularity of the event associated information; and
wherein the first text set represents a candidate text set that corresponds to the candidate texts in the popularity interval and meets a preset set condition.

19. The non-transitory storage medium according to claim 17, wherein the determining a plurality of popularity intervals, based on the posting time of the candidate text in each of the candidate text sets, a preset first-text number and text attributes of the candidate texts comprises:
for each candidate text set, determining the posting time of the candidate texts set based on the posting time of the candidate texts in the candidate text set;
sorting the at least one candidate text set based on the posting time of each candidate text set to obtain a set sorting result; and
dividing the set sorting result into the plurality of popularity intervals based on the preset first-text number and the text attributes of each candidate text.

20. The non-transitory storage medium according to claim 18, wherein the dividing the set sorting result into the plurality of popularity intervals based on the preset first-text number and the text attributes of each candidate text comprises:
determining popularity information corresponding to each candidate text set based on the text attributes of the candidate texts in each candidate text set;
determining a popularity information range of each popularity interval based on the preset first-text number and the text attributes of each candidate text; and
dividing the candidate text set in the set sorting result to obtain the plurality of popularity intervals based on the popularity information range and the popularity information of the candidate text set.
